(19) United States
(12) Patent Application Publication
(10) Pub. No.: US 2025/0214030 A1
(43) Pub. Date: Jul. 3, 2025

(54) URETHANE CATIONIC POLY(IONIC LIQUIDS), THEIR DENSE AND COMPOSITE MEMBRANES, THEIR USE AND METHOD FOR REMOVING CO2 FROM NATURAL GAS OR AN EXHAUST GAS

(71) Applicants: PETRÓLEO BRASILEIRO S.A. – PETROBRAS, Rio de Janeiro (BR); UNIÃO BRASILEIRA DE EDUCAÇÃO E ASSISTÊNCIA - MANTENEDORA DA PUCRS, Porto Alegre (BR)

(72) Inventors: Sandra Mara OLIVEIRA EINLOFT, Porto Alegre (BR); Leonardo DOS SANTOS PEREIRA, Rio de Janeiro (BR); Franciele LONGARAY BERNARD, Porto Alegre (BR); Fernando GUSMAN BRANDAO, Rio de Janeiro (BR); Ana Paula SANTANA MUSSE, Rio de Janeiro (BR); Guilherme Thomas GEREVINI DIAS, Porto Alegre (BR)

(21) Appl. No.: 19/001,137

(22) Filed: Dec. 24, 2024

(30) Foreign Application Priority Data
Dec. 28, 2023 (BR) 1020230276679

(51) Int. Cl. B01D 53/22; B01D 69/02; B01D 69/10; B01D 71/82; C08G 71/04; C10L 3/10

(52) U.S. Cl. CPC B01D 53/228; B01D 69/02; B01D 69/107; B01D 71/82; C08G 71/04; C10L 3/104; B01D 2257/504; B01D 2325/022; B01D 2325/16; C10L 2290/548

(57) ABSTRACT

The present disclosure relates to example embodiments of urethane cationic poly(ionic liquids) (PILs) based on hydroxylated Ionic Liquids (ILs) cations, of formula (I), as well as to dense membranes and composite membranes, on polymeric supports, of urethane cationic PILs. The present disclosure also relates to embodiments of the use of said membranes in the removal of CO₂ from natural gas or an exhaust gas and to a method for removing CO₂ from natural gas or an exhaust gas comprising subjecting a stream of the natural gas or the exhaust gas through the membranes of the present disclosure.

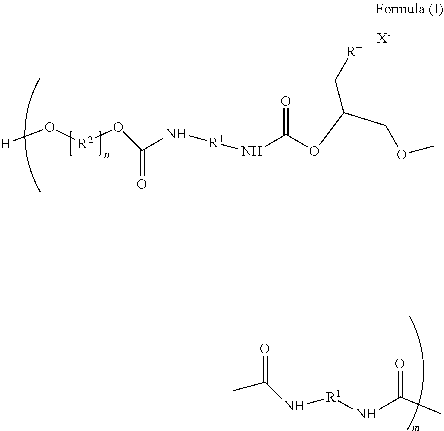

### FIELD OF THE DISCLOSURE

The present disclosure is part of the field of natural gas processing, more precisely for CO₂ recovery, and describes urethane cationic poly(ionic liquids) (PILs), dense and composite membranes based on said PILs, as well as their use and method for removing CO₂ from natural gas or exhaust gas using said membranes.

### BACKGROUND OF THE DISCLOSURE

The recovery of carbon dioxide (CO₂) derived from industrial waste gases is of great importance, both for the reuse of CO₂ and from an environmental point of view. Considering the gigantic oil reserves of the Brazilian Pre-Salt that have a high gas/oil ratio and a high CO₂ content, the importance of CO₂ management in natural gas processing becomes even more evident. Thus, the improvement of solvents and adsorbents as existing technologies for capturing CO₂ from gas streams, in addition to the optimization of the membrane permeation process, incorporating the development of new materials, have been investigated to overcome challenges related to the increase in CO₂ concentration in natural gas and the need to operate at higher pressures. The commercial membranes frequently used for separating CO₂ from natural gas in stationary offshore production units are polymeric membranes. However, they have limitations, such as low permeability and selectivity, plasticization at high temperatures, as well as insufficient thermal and chemical stability as the CO₂ concentration in natural gas increases. These limitations of commercial polymeric membranes have motivated researchers to look for alternative materials.

Membrane systems have been used in offshore stationary production units to remove CO₂ from natural gas. Examples of commercially available CO₂ removal membranes include: cellulose acetate spiral wound modules, cellulose acetate hollow fiber membrane modules, polyimide hollow fiber membrane modules, spiral wound perfluoropolymer membrane modules, and cellulose triacetate hollow fiber membrane modules. In terms of energy, membrane separation is very efficient, as it is a continuous process without the need for solvent regeneration or desorption due to temperature/pressure variation. The CO₂ membrane separation unit is relatively compact, easy to operate, control, and scale up. An efficient membrane should have characteristics such as high permeation rate and selectivity, low fouling rate, long service life, and mechanical, thermal, and chemical stability under operating conditions. However, it is difficult for a single membrane to satisfy all these requirements. It is known, for example, that cellulose acetate remains the main material used as a separation membrane in natural gas processing plants, with selectivity values between 10 and 15. This is due to the fact that most materials lose selectivity when tested with CO₂/CH₄ mixtures, since the processing takes place at high pressures. For large-scale processes, cellulose acetate only becomes economically viable when there are CO₂ concentrations above 10% in moles when compared to other CO₂ capture technologies.

Ionic liquids (ILs) have unique physicochemical properties, such as high solubility and selectivity for CO₂, low volatility, among others. Compared to conventional organic solvents, ILs have high thermal resistance and less toxicity to the environment. However, the high viscosity and cost of ILs, as well as the low CO₂ sorption/desorption rates compared to amine solutions, restrict their application for CO₂ capture (Mecerreyes D (2011) Polymeric ionic liquids: broadening the properties and applications of polyelectrolytes. Prog Polym Sci 36:1629 to 1648; Zhu J, He K, Zhang H, Xin F (2012) Effect of swelling on carbon dioxide adsorption by poly(ionic liquid)s. Adsorpt Sci Technol 30:35 to 41; Bernard F L, Polesso B B, Cobalchini F W et al (2016) CO₂ capture: tuning cation-anion interaction in urethane based poly (ionic liquids). Polymer 102:199 to 208; Dai Z, Noble R D, Gin D L et al (2016) Combination of ionic liquids with membrane technology: a new approach for CO₂ separation. J Memb Sci 497:1 to 20; Eftekhari A, Saito T (2017) Synthesis and properties of polymerized ionic liquids. Eur Polym J 90:245 to 272).

To overcome the disadvantages related to high viscosity and cost, ILs can be incorporated into chain-forming polymers to create Polymers of Ionic Liquids (PILs). These materials show better CO₂ capture performance compared to pure ILs (Sadeghpour M, Yusoff R, Aroua M K (2017) Polymeric ionic liquids (PILs) for CO₂ capture. See Chem Eng 33:183 to 200; Hasib-ur-Rahman M, Siaj M, Larachi F (2010) Ionic liquids for CO₂ capture-development and progress. Chem Eng Process Process Intensif 49:313 to 322; Zhao Z, Dong H, Zhang X (2012) The research progress of CO₂ capture with ionic liquids. J Chem Eng 20:120 to 129). PILs combine the advantageous properties of ILs and polymers, expanding the range of applications of these materials in different areas (Mecerreyes D (2011) Polymeric ionic liquids: broadening the properties and applications of polyelectrolytes. Prog Polym Sci 36:1629 to 1648; Green O, Grubjesic S, Lee S, Firestone M A (2009) The design of polymeric ionic liquids for the preparation of functional materials. Polym Rev 49:339 to 360; Yuan J, Antonietti M (2011) Poly(ionic liquid)s: polymers expanding classical property profiles. Polymer 52:1469 to 1482; Yuan J, Mecerreyes D, Antonietti M (2013) Poly(ionic liquid)s: an update. Prog Polym Sci 38:1009 to 1036). These functional polymers can be applied as alternative solid sorbents for CO₂ capture and separation. PILs generally exhibit higher CO₂ sorption capacity compared to corresponding ILs (Tang J, Sun W, Tang H et al (2005) Enhanced CO₂ absorption of poly(ionic liquid)s. Macromolecules 38:2037 to 2039; Supasitmongkol S, Styring P (2010) High CO₂ solubility in ionic liquids and a tetraalkylammonium-based poly (ionic liquid). Energy Environ Sci 3:1961 to 1972). Furthermore, the sorption/desorption process is faster and fully reversible (Sadeghpour M, Yusoff R, Aroua M K (2017) Polymeric ionic liquids (PILs) for CO₂ capture. See Chem Eng 33:183 to 200; Hasib-ur-Rahman M, Siaj M, Larachi F (2010) Ionic liquids for CO₂ capture-development and progress. Chem Eng Process Process Intensif 49:313 to 322; Tang J, Tang H, Sun W et al (2005) Low-pressure CO₂ sorption in ammonium-based poly(ionic liquid)s. Polymer 46:12460 to 12467; Shaplov A S, Marcilla R, Mecerreyes D (2015) Recent advances in innovative polymer electrolytes based on poly(ionic liquid)s. Electrochim Acta 175:18 to 34). Furthermore, PILs have better selectivity to separate CO₂ from other gases (Eftekhari A, Saito T (2017) Synthesis and properties of polymerized ionic liquids. Eur Polym J 90:245 to 272; Bara J E, Gin D L, Noble R D (2008) Effect of anion on gas separation performance of polymer room-temperature ionic liquid composite membranes. Ind Eng Chem Res 47:9919 to 9924; Bara J E, Gabriel C J, Hatakeyama E S et al (2008) Improving CO₂ selectivity in polymerized room-temperature ionic liquid gas separation membranes through incorporation of polar substituents. J Memb Sci 321:3 to 7).

In this context, the present disclosure encompasses dense and composite PIL membranes based on polyurethane (PU). These membranes are applicable to the process of separating CO₂ from natural gas streams, as they have proven to be highly selective, permeable, with good mechanical properties, and are thermally and chemically stable. Thus, they can be applied in natural gas treatment plants or in the treatment of exhaust gas streams as a replacement for conventional polymeric membranes.

### STATE OF THE ART

Some documents from the state of the art deal with the use of ionic liquids and poly(ionic liquids) in the separation of CO₂ from natural gas.

The document entitled “Polyurethane-based poly (ionic liquid)s for CO2 removal from natural gas”, discloses the synthesis of polyurethane-based PILs for separation of CO₂ from natural gas. In particular, the PILs disclosed in said article are based on polycarbonate and polycaprolactam polyols and the counter cations imidazolium (1-n-butyl-3-methylimidazolium), phosphonium (tetrabutylphosphonium), ammonium (tetrabutylammonium) and pyrrolidinium (1-butylmethylpyrrolidinium).

However, the present disclosure relates to cationic PILs and the PILs disclosed in the article mentioned above are anionic. Furthermore, the PILs of the present disclosure are based on cations functionalized with the hydroxyl group, preferably on the N-glyceryl-N-methylimidazolium cation, which is considerably different from the imidazolium derivative used in the PILs disclosed in this article. Furthermore, the PILs disclosed in the article were not evaluated for their ability to form dense and composite membranes, as well as their permeability and selectivity to CO₂.

The document entitled “Poly(ionic liquid)s-based polyurethane blends: effect of polyols structure and ILs counter cations in CO₂ sorption performance of PILs physical blends” discloses the synthesis of polyurethane-based PIL blends for the separation of CO₂ from natural gas or N₂. In particular, the PIL blends disclosed in the aforementioned article are based on the polyols polycarbonate and poly(tetramethylene ether) glycol and the counter cations imidazolium (1-n-butyl-3-methylimidazolium) and phosphonium (tetrabutylphosphonium).

Like the previous document, the present disclosure differs from that disclosed in this article since it refers to cationic, not anionic, PILs. Furthermore, the cations functionalized with the hydroxyl group, preferably the N-glyceryl-N-methylimidazolium cation, are considerably different from the imidazolium derivative used in the PILs disclosed in this article. Furthermore, this article does not disclose data on permeability and selectivity to CO2.

In its turn, the patent document BR 102014029773-1, entitled “POLI (LÍQUIDOS IÔNICOS) COM BASE EM ESTRUTURAS URETANO E PROCESSOS DE OBTENçÃO DOS MESMOS” (POLY (IONIC LIQUIDS) BASED ON URETHANE STRUCTURES AND PROCESSES FOR OBTAINING THEM), discloses several polyurethane-based PILs for separating CO₂ from natural gas, particularly anionic PILs based on the polyols polycaprolactam, polytetramethylene glycol, polyethylene glycol and polypropylene glycol diol, on the diisocyanates HDI (hexamethylene diisocyanate), IPDI (isophorone diisocyanate), HMDI (4,4′-dicyclohexylmethane diisocyanate) and on the imidazolium counter cations [bmim]⁺ (1-butyl-3-methylimidazolium), [dmbmim]⁺ (3-methyl-1-butyl-3,3-dimethylimidazolium), [emim]⁺ (1-ethyl-3-methylimidazolium), [hmim]⁺ (1-hexyl-3-methylimidazolium), [pmim]⁺ (1-methyl-3-propylimidazolium), [omim]⁺ (1-methyl-3-octylimidazolium), or cationic PILs based on the same polyols and diisocyanates, combining the counter cations [bmim]⁺, [dmbmim]⁺, [emim]⁺, [hmim]⁺, [pmim]⁺, [omim]⁺ with the anions PF₆⁻ (hexafluorophosphate), BF₄⁻ (tetrafluoroborate), Cl⁻, Br⁻, I⁻, F⁻, Tf₂N⁻, CF₃SO₃⁻, (CF₃SO₂)₂N⁻.

However, unlike the PILs used in the present disclosure, the PILs disclosed in said document do not have a sufficient average numerical molar mass to form membranes, due to their low average numerical molar mass (approximately 5,000 Mn). Furthermore, the counter cations used in the cationic PILs disclosed in the aforementioned patent document are considerably different from the cations functionalized with the hydroxyl group, preferably N-glyceryl-N-methylimidazolium, used in the PILs of the present disclosure.

The paper entitled “Separation of Carbon Dioxide from Nitrogen or Methane by Supported Ionic Liquid Membranes (SILMs): Influence of the Cation Charge of the Ionic Liquid” discloses membranes wherein ionic liquids were supported. In particular, the ionic liquids used in the studies disclosed in the aforementioned paper are derivatives of imidazolium, pyrrolidinium, piperidinium and morpholinium, comprising a triethylene glycol sidechain and with tosylate as counter anion. The support material of the membranes were porous γ-alumina discs.

This paper reports the synthesis of mono- and di-cationic ionic liquids and their impregnation in porous γ-alumina discs, these materials being considered SILM—Supported Ionic Liquid Membranes. However, the teachings regarding the properties of SILMs are not necessarily extrapolatable to PILs. This is because in SILMs the ionic liquids are the main ones involved in selectivity, while in PILs the composition of the polymer in general has an influence on selectivity due to the structure of the polymer, in addition to the ionic liquid.

The document entitled “Polymeric ionic liquid-based membranes: influence of polycation variation on gas transport and CO₂ selectivity properties” discloses membranes based on PILs with polycations based on imidazolium, pyridinium, pyrrolidinium, ammonium and cholinium and with the counter anion NT₂F, teaching that the counter cation has an influence on the performance of the membranes, particularly on the permeability for CO₂. The document also discloses composite membranes wherein poly(tetrafluoroethylene) (PTFE) membranes were impregnated with solutions containing the prepared PILs and 10% of the corresponding ILs.

However, this study reported in the aforementioned article has no similarity with the present disclosure, which refers to the preparation of PIL composite membranes using different supports, such as, for example, nylon (Ny), polytetrafluoroethylene (PTFE), polyvinylidene fluoride (PVDF), among others.

Finally, the patent document WO 2011/046661, entitled “IMIDAZOLIUM-BASED ROOM-TEMPERATURE IONIC LIQUIDS, POLYMERS MONOMERS AND MEMBRANES INCORPORATING SAME”, discloses gels, solutions, films, membranes, compositions and other materials containing polymerized and/or non-polymerized room-temperature ionic liquids, useful in, among others, gas separation. The ionic liquids disclosed in the document WO 2011/046661 are based on imidazolium that are optionally substituted, such as by one or more hydroxyl groups. Furthermore, said document discloses composite materials comprising polymerized and non-polymerized ionic liquids.

Although the aforementioned document uses porous supports for the preparation of composite membranes similar to those of the present disclosure, the structures of the PILs used are different, in addition to the method of preparing the membranes. Therefore, said document differs from the present disclosure in that it does not address the synthesis of PIL membranes based on urethane structures containing cations functionalized with the hydroxyl group, preferably the N-glyceryl-N-methylimidazolium cation, and does not use the same method of preparing composite membranes described in the present disclosure.

Thus, the technical solutions described in the state of the art for the separation of CO₂ from CH₄, in addition to being different from the present disclosure, often lack evidence regarding their permeability and selectivity properties to CO₂. Therefore, there is a need for the provision of polymers and membranes useful in the separation of CO₂ from CH₄ with improved permeability and selectivity properties.

### SUMMARY OF THE DISCLOSURE

The present disclosure provides example embodiments of urethane cationic poly(ionic liquids) (PILs) based on hydroxyl group functionalized ionic liquid (IL) cations, as well as urethane cationic PIL membranes based on hydroxyl group functionalized IL cations, dense and composite membranes, on polymeric supports such as nylon, PTFE and PVDF. The present disclosure also relates to example embodiments of the use of said membranes in the removal of CO₂ from natural gas or an exhaust gas and to a method for removing CO₂ from natural gas or an exhaust gas comprising subjecting a stream of natural gas or exhaust gas through the membranes of the present disclosure.

### BRIEF DESCRIPTION OF THE DRAWINGS

In order to obtain a complete and total view of the objective of this disclosure, the Figures to which reference is made are shown, as follows.

FIG. 1 is a cross-sectional micrograph of the cationic PIL membranes based on N-glyceryl-N-methylimidazolium, polycarbonate diol, hexamethylene diisocyanate (HDI) and counter anion NT₂F (PILPCHDI-NT₂F), supported on 0.22 μm nylon, at 200× magnification, according to an example embodiment of the present disclosure.

FIG. 2 is a graphical representation of the gas permeation system used in Examples 4 and 6 to measure the permeability of the prepared membranes, comprising (1) CO₂ cylinder, (2) pressure indicator, (3) permeation cell, (4) data acquisition system and (5) vacuum pump, according to example embodiments of the present disclosure.

FIG. 3 is a synthetic scheme for the preparation of the cationic PILs of the present disclosure based on N-glyceryl-N-methylimidazolium, wherein the chemical structures of the counter anions NT₂F⁻, BF₄⁻ and PF₆⁻ are represented, according to an example embodiment of the present disclosure.

FIG. 4 is a synthetic scheme for the preparation of N-glyceryl-N-methylimidazole chloride ([GLYMIM]Cl) (C), from the reaction of N-methylimidazole (A) with 3-chloro-1,2-propanediol (B), used in the preparation of some PILs of examples of the present disclosure.

FIG. 5 shows the representation of the formulas of the ionic liquids [GLYMIM]PF₆; [GLYMIM]BF₄ and [GLYMIM]NT₂F, according to example embodiments of the present disclosure.

FIG. 6 shows the chemical structure of different polyols that can be used in the synthesis of the PILs of the present disclosure, namely: (A) polyether; (B) polyester; (C) polycarbonate; (D) acrylic; and (E) polybutadiene diol, according to example embodiments of the present disclosure.

FIG. 7 shows photos of the membranes obtained after drying of the PILs based on [GLYMIM]Cl, [GLYMIM]PF₆, [GLYMIM]BF₄ and [GLYMIM]NT₂F, wherein the polyol is polycarbonate and the diisocyanate is hexamethylene diisocyanate, according to an example embodiment of the present disclosure.

FIG. 8 shows the NMR spectrum of the IL [GLYMIM]Cl, according to an example embodiment of the present disclosure.

FIG. 9 shows the NMR spectrum of the IL [GLYMIM]NT₂F, according to an example embodiment of the present disclosure.

FIG. 10 shows the Fourier Transform Infrared (FTIR) spectra of the ILs [GLYMIM]Cl, [GLYMIM]BF₄, [GLYMIM]PF₆ and [GLYMIM]NT₂F, according to an example embodiment of the present disclosure.

FIG. 11 shows the infrared spectra of the PU and cationic PILs. FIG. 11 shows the typical spectra obtained for the PILs synthesized with the diisocyanate HDI, polyol polycarbonate diol (PCD) MM=2000 gmol⁻¹ and different ILs ([GLYMIM]Cl, [GLYMIM]BF₄, [GLYMIM]PF₆, [GLYMIM]NT₂F) and a typical spectrum of the polyurethane (PU) obtained with the diisocyanate HDI and polyol PCD MM=2000 gmol⁻¹, according to an example embodiment of the present disclosure.

FIG. 12 shows the CO₂ capture results obtained for dense membranes of PILs synthesized with the diisocyanate HDI, polyol polycarbonate diol (PCD) and the ILs [GLYMIM]Cl (PIL-PCHDI-Cl), [GLYMIM]BF₄ (PIL-PCHDI-BF₄), [GLYMIM]PF₆ (PIL-PCHDI-PF₆) and [GLYMIM]NT₂F (PIL-PCHDI-NT₂F) and PU, at 0.1 MPa (1 bar) and 1 MPa (10 bar), according to an example embodiment of the present disclosure.

### DETAILED DESCRIPTION OF THE DISCLOSURE

The present disclosure relates to example embodiments of polyurethane cationic poly(ionic liquids) based on hydroxylated cations. In particular, the cationic PILs comprise monomers formed from a diol moiety, an ionic liquid and a diisocyanate. The urethane cationic PILs of the present disclosure have the formula (I):

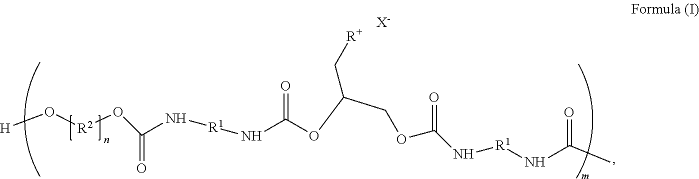

wherein X⁻ is a counter anion selected from chloride (Cl⁻), bromide (Br⁻), iodide (I⁻), triflate (TFO⁻), thiocyanate (SCN⁻), tris(pentafluoroethyl) trifluorophosphate (FAP⁻), dicyanamide (DCA⁻), nitrate (NO₃⁻), perchlorate (ClO₄⁻), bis(trifluoromethanesulfonyl) imide (NT₂F⁻), tetrafluoroborate (BF₄⁻), hexafluorophosphate (PF₆⁻), bis(pentafluoroethylsulfonyl) imidate, tricyanomide, taurinate, tetracyanoborate, formate, acetate, propionate and butyrate;
R¹ is a C₁-C₆ alkyl group; C₃-C₈ cycloalkyl, optionally substituted with C₁-C₆ alkyl; mono- or bicyclic 6- to 10-membered aryl, optionally substituted with C₁-C₆ alkyl; C₆ aryl-C₁-C₆ alkyl-(C₆ aryl)₁₋₂; or C₁-C₆ alkyl-C₆ aryl-C₁-C₆ alkyl;
R² is a polyether, polyester, polycarbonate diol, polytetramethylene glycol, polycaprolactone, acrylic, polybutadiene, or aliphatic C₄-C₁₀ alkyl group;
R is

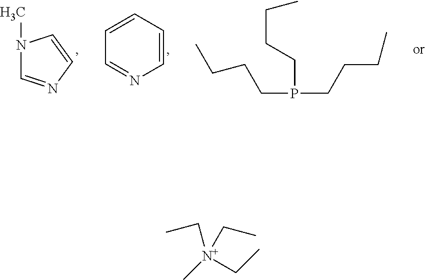

n is an integer between 4 and 45; and
m is an integer between 15 and 150.

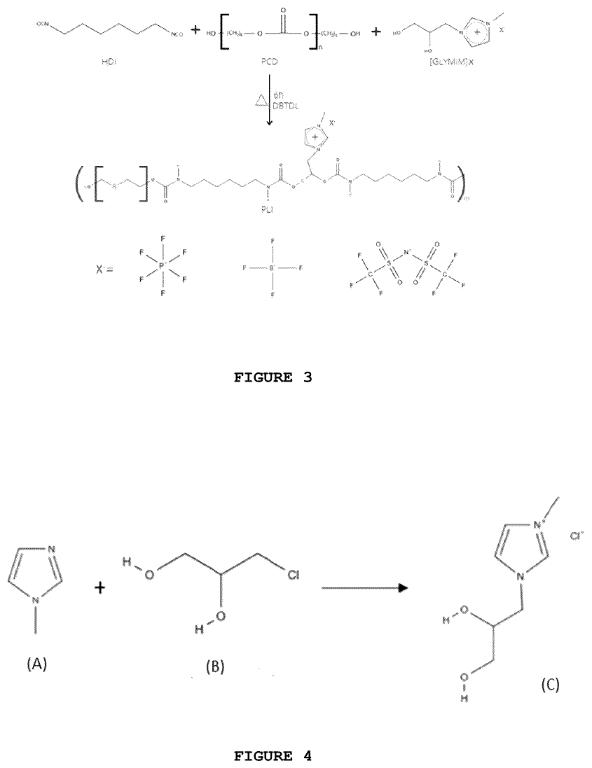

As shown in FIG. 3, the cationic PILs of the present disclosure are formed from a polyol diol, a diisocyanate and an ionic liquid.

In an example embodiment, the polyols used are polycarbonate diol (PCD), polytetramethylene glycol (PTMG), polycaprolactone (PCL), polyether, polyester, acrylic and polybutadiene diol. In an even more preferred embodiment, the polyol used is PCD, PTMG or PCL, even more preferably PCD.

The diisocyanate used may be a commercially available diisocyanate, as indicated in Table 1 below.

TABLE 1
Suitable diisocyanates for the PILs of the present
disclosure

| | | | | NCO |
|---|---|---|---|---|
| | | | Molecular | content |
| Name | Formula | Structure | weight | (%) |
| 2,4-toluene diisocyanate (TDI)/1- methyl-benzene 2,4- diisocyanate | C₉H₆O₂N₂ | 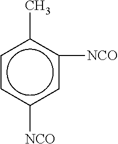 | 174.2 | 48.2 |
| 2,6-toluene diisocyanate (TDI)/1- methyl-benzene 2,6- diisocyanate | C₉H₆O₂N₂ | 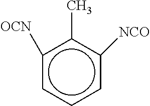 | 174.2 | 48.2 |
| 4,4′-diphenyl methane diisocyanate (MDI)/1,1′-methylene bis(4-benzene isocyanate) | C₁₅H₁₀O₂N₂ | 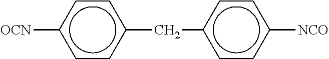 | 250.3 | 33.6 |
| 2,4′-diphenyl methane diisocyanate (MDI)/1- isocyanate-2-(4-phenyl isocyanate) methylbenzene | C₁₅H₁₀O₂N₂ | 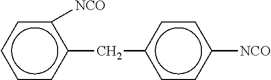 | 250.3 | 33.6 |
| 2,2′-diphenyl methane diisocyanate (MDI)/1,1′-methylene bis(benzene 2- isocyanate) | C₁₅H₁₀O₂N₂ | 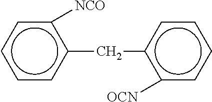 | 250.3 | 33.6 |
| Hexamethylene diisocyanate (HDI)/hexane 1,6- diisocyanate | C₈H₁₂O₂N₂ | OCN—(CH₂)₆—NCO | 168.2 | 49.9 |
| Isophorone diisocyanate (IPDI)/5- isocyanate-1-(methyl isocyanate)-1,3,3′- trimethyl cyclohexane | C₁₂H₁₈O₂N₂ | 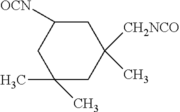 | 222.3 | 37.8 |
| Meta-tetramethylxylene diisocyanate (TMXDI)/bis(iso- cyanate-1-methyl-1- ethyl)-1,3-benzene | C₁₄H₁₆N₂O₂ | 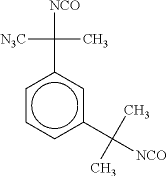 | 244.3 | 34.4 |
| 4,4′- dicyclohexylmethane diisocyanate (HMDI)/1,1′- methylenebis(4- isocyanate cyclohexane) | C₁₅H₂₂O₂N₂ | 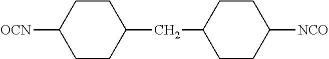 | 262.3 | 32.0 |
| Triphenylmethane- 4,4′,4″- triisocyanate/1,1′,1″- methylenetris(benzene 4-isocyanate) | C₂₂H₁₃O₃N₃ | 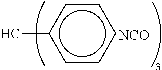 | 367.4 | 22.86 |
| Naphthalene 1,5- diisocyanate (NDI)/naphthalene 1,5- diisocyanate | C₁₂H₆O₂N₂ | 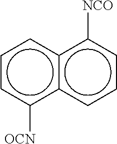 | 210.2 | 40.0 |

In an example embodiment, the diisocyanate used is hexamethylene diisocyanate (HDI), isophorone diisocyanate (IPDI), 4,4-dicyclohexylmethane diisocyanate (H12MDI), 2,2′-diphenyl methane diisocyanate (MDI) and 2,4′-diphenyl methane diisocyanate (MDI). In an even more preferred embodiment, the diisocyanate is HDI.

In an example embodiment, the counter anion is Cl⁻, BF₄⁻ or PF₆⁻. In an even more preferred embodiment, the counter anion is BF₄⁻.

In an even more preferred embodiment, the cationic PIL is N-glyceryl-N-methylimidazolium and is formed by PCD, HDI and the counter anion is BF₄⁻.

The cationic PILs of the disclosure present high thermal stability (Initial T between 300° C. and 340° C.). The stress-strain curves obtained demonstrated that the PU-based PILs had characteristics of elastomer materials, with low stresses and large deformations. It is worth noting that the cationic PILs of the present disclosure had good mechanical resistance (Young's Moduli between 15 to 20 MPa).

The cationic PILs of the present disclosure are prepared in a single step, as shown in FIG. 3. To do so, the polyol is melted in the reactor, the dibutyltin dilaurate (DBTDL) catalyst is added, the reaction temperature is measured, which should be between 55° C. and 70° C., depending on the polyol used (for example, 70° C. for PCD, 60° C. for PTMG and 55° C. for PCL), the diisocyanate dissolved in methyl ethyl ketone (MEK) is added, forming a prepolymer. After the formation of the prepolymer, the ionic liquid is added, and after homogenization of the solution, the remaining diisocyanate is added in solvent medium. The end of the reaction is accompanied by the disappearance of the free NCO band (around 2270 cm⁻¹) in the infrared spectrum.

The ionic liquid used in the preparation of the PILs of the disclosure is prepared from the functionalization of the cation used, followed by the preparation of the ionic liquid. The preparation of the ionic liquids functionalized with hydroxyl groups occurs by the reaction of an alcohol (di or polyfunctional) containing a chloride or bromide group with an example cation (imidazolium, phosphonium, triethylammonium or pyridinium). Thus, a range of different functionalized ionic liquids (ILs) can be obtained and used in the synthesis of the cationic PILs of the disclosure.

In a second embodiment, the present disclosure relates to dense membranes of the urethane cationic PILs of the disclosure.

In an example embodiment, the thickness of the dense membranes is 80 to 120 μm.

The dense membranes of the present disclosure can be prepared by methodologies known in the art. For example, casting, solvent evaporation, extrusion, lamination, precipitation, blowing or phase inversion.

In a third embodiment, the present disclosure relates to membranes composed of the urethane cationic PILs of the disclosure with different pore sizes. The composite membranes can be prepared using the PILs and different polymeric supports such as nylon (Ny), polytetrafluoro ethylene (PTFE), polyvinylidene fluoride (PVDF), cellulose acetate, cellulose nitrate, cellulose ester (MCE) and polyethersulfone (PES). The selected supports have thermal and chemical stability, good mechanical properties, easy processing and high resistance to solvents. In addition, they have a hydrophobic character, therefore being indicated for applications in humid environments.

To prepare the composite membranes, a PIL solution is dissolved in a suitable solvent, for example, THF, acetone, methyl ethyl ketone or isopropyl alcohol (10% w/w), and after complete solubilization, the solution is deposited on the support by the casting method. Then, the supports with the deposited solution are dried at room temperature for 7 days to form the composite membranes.

The dense and composite membranes of the present disclosure have extremely attractive modulable properties for application in CO₂ removal processes. The synthesis of the formation of the PILs of the present disclosure is easily scalable and low cost when compared to the synthesis of traditional PILs (via radical polymerization), since the main chain of the polymeric structure is formed mainly by PU and a small amount of ionic liquid.

Furthermore, the manufacture of the composite membranes uses easily accessible commercial supports, which do not offer resistance to gas flow, but provide greater mechanical integrity to the top selective layer, increasing permeance. The PIL membranes of the present disclosure have the potential to considerably increase the performance of polymeric membranes without loss of mechanical properties, being capable of replacing commercial membranes in existing plants with the possibility of increasing the gas treatment flow rate or greater enrichment of natural gas.

The PIL membranes of the present disclosure combine extremely attractive modular properties for application in CO₂ removal processes from natural gas, providing an economically promising product, due to its good thermal stability, permeability and high selectivity to CO₂. Parameters such as permeability and high selectivity are important and can promote an increase in process efficiency and a reduction in fixed and operational costs of the membrane system. Advantages of the membranes of the present disclosure are, for example, the need for a smaller membrane area (in view of their greater effectiveness and selectivity, requiring fewer membranes than those conventionally used) and increased production of the oil and gas platform (possibility of treating a greater flow of natural gas with the same number of elements).

Since the PIL membranes of the present disclosure have greater selectivity than conventional polymeric membranes, a reduction in the flow rate of the stream that permeates the membrane is expected. Since this stream is rich in CO₂, the reduction in flow requires less compression energy to reinject this CO₂ into the reservoir. The reduction in compression energy requires less gas burning in the turbines to generate this energy, which contributes to the reduction of greenhouse gas emissions. In addition, the use of these membranes to capture CO₂ from exhaust gas streams would also have a major impact from an environmental point of view, since these come from combustion in turbines and contain a large amount of CO₂ that is emitted into the atmosphere.

In a fourth embodiment, the present disclosure relates to the use of the dense and composite membranes of the disclosure to remove CO₂ from natural gas. In a fifth embodiment, the present disclosure relates to the use of the dense and composite membranes of the disclosure for removing CO₂ from exhaust gases.

In a sixth embodiment, the present disclosure relates to a method for removing CO₂ from natural gas comprising passing a stream of natural gas through a dense or composite membrane of PILs of the present disclosure.

In a seventh embodiment, the present disclosure relates to a method for removing CO₂ from an exhaust gas comprising passing a stream of exhaust gas through a dense or composite membrane of PILs of the present disclosure.

In order to demonstrate its potential, the present disclosure will be described in more detail in terms of the examples implemented. It should be noted that the following description is only intended to elucidate the understanding of the proposed disclosure and to disclose, in more detail, the implementation of the disclosure without limiting it to the same. Thus, variables similar to the examples are also within the scope of the disclosure.

### Example 1: Synthesis of ILs

To prepare the IL, the reaction was maintained throughout the entire time in a glycerin bath and constant magnetic stirring at a temperature of 70° C. During the first hour of reaction, 10 mL (0.11 mol) of 3-chloro-1,2-propanediol were dropwise added to 12 mL (0.15 mol) of N-methylimidazole. The reaction conditions were maintained for 72 h.

After 72 h, the reaction was removed from the heat and washed 6 times with ethyl acetate. The resulting material was then placed in a glycerin bath to maintain a constant temperature of 70° C. and dried under vacuum for 24 hours. The product was kept in a nitrogen atmosphere and stored. The result was a yellow oil. Anion exchanges were performed in acetonitrile from the reaction of [GLYMIM]Cl with the respective salts, lithium bis(trifluoromethane sulfonyl)imide (LiNT₂F) to form [GLYMIM]NT₂F, lithium tetrafluoroborate LiBF₄ to form [GLYMIM]BF₄ and sodium hexafluorophosphate (NaPF₆) to form [GLYMIM]PF₆. The reagents used in the ion exchange procedure ([GLYMIM]Cl, LiBF₄, LiNT₂F and LiPF₆) are soluble in acetonitrile while the byproduct LiCl is not soluble, and the separation of the byproducts was performed by simple filtration. Afterwards, vacuum drying was carried out to remove any excess solvent and moisture.

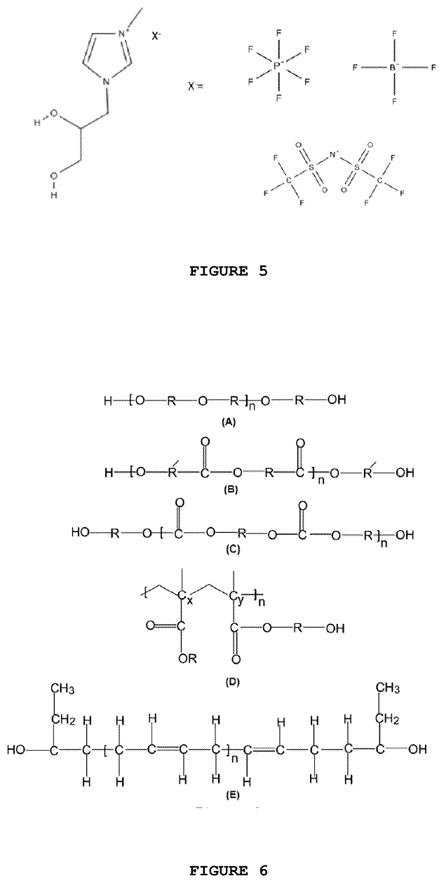

FIG. 5 shows the structures of the ILs [GLYMIM]Cl, [GLYMIM]PF₆, [GLYMIM]BF₄ and [GLYMIM]NT₂F.

The ILs functionalized with hydroxyl groups were characterized by Fourier Transform Infrared Spectroscopy (FTIR, PerkinElmer Spectrum 100 spectrometer) in transmission mode in the range 4000 to 650 cm⁻¹, to verify the structures and by Nuclear Magnetic Resonance (NMR) using a Bruker Ascend 400 NMR.

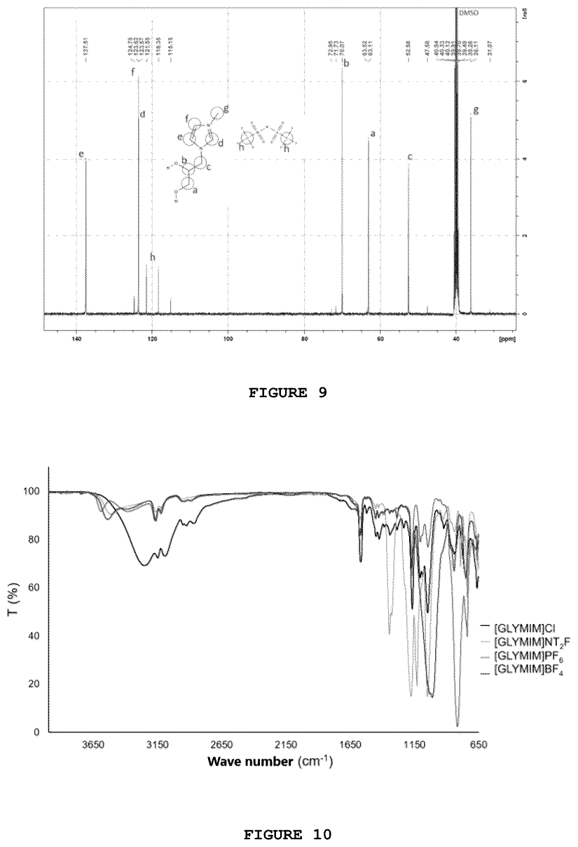

The FTIR analyses showed the characteristic bands of the ILs functionalized with hydroxyl groups, confirming that the materials could be obtained. The characteristic NMR peaks of the ILs were also observed, evidencing their obtainment. For illustrative purposes, the NMR of IL functionalized with N-glyceryl-N-methylimidazole chloride [GLYMIM]Cl (FIG. 8) and IL [GLYMIM]NT₂F (FIG. 9), obtained after exchanging the chloride anion (Cl⁻) for NT₂F⁻, are shown. The FTIR of ILs [GLYMIM]Cl, [GLYMIM]BF₄, [GLYMIM]PF₆, [GLYMIM]NT₂F are also shown in FIG. 10.

The ¹H NMR spectrum (DMSO-d₆) of IL ([GLYMIM])Cl (FIG. 8) showed the characteristic peaks: 3.4 ppm (2H, CH₂), 3.7 ppm (1H, CH), 3.9 (3H, CH₃), 4.4 ppm (2H, CH₂), 5.3 ppm (1H, OH), 5.6 ppm (1H, OH), 7.7 ppm (1H, CH), 7.8 ppm (1H, CH) and 9.2 ppm (1H, CH)2,3,13.

The ¹³C NMR spectrum of LI [GLYMIM]NT₂F, which is the only one wherein the anion has carbons in its structure, is shown in FIG. 9. Through this analysis, it was possible to identify the peaks corresponding to the carbons of the cationic structure ([GLYMIM]) and also the carbons of the anion structure (NT₂F): ¹³C NMR (DMSO) δ: 36.1 (CH₃); 52.5 (—N+CH₂); 63.1 (CH₂OH); 70.07 (CHOH); 123.5 (CH); 123.6 (CH), 137.5 (CH), 117.4 (2C, NT₂F), evidencing the effective exchange of the Cl anion for NT₂F.

IL [GLYMIM]Cl had the expected bands confirming the obtaining of the desired product (FIG. 10), it was possible to visualize the OH band between 3281 and 3239 cm⁻¹, as well as those related to the imidazolium ring close to 1670 cm⁻¹ (C=C), 1604 cm⁻¹ (N—H) and 1371 cm⁻¹ (aromatic C—N). By replacing the Cl⁻ anion in the IL structure, the same bands related to the cationic part of the IL can be observed, however, changes in the spectrum are evident, as shown in FIG. 10.

The insertion of the NT₂F anion causes the appearance of bands between 1200 cm⁻¹ and 1400 cm⁻¹, characteristic for this ion, as well as others close to 1060 cm⁻¹ related to S=O bonds, 846 cm⁻¹ related to N—S bonds, 789 cm⁻¹ related to C—S bonds and 751 cm⁻¹ related to C—F bonds. The replacement of Cl by the BF₄ and PF₆ anions also caused changes in the spectra, causing the appearance of bands at 815 cm⁻¹ related to the P—F bonds of PF₆ and at 1050 cm⁻¹ related to the B—F bonds of BF₄.

### Example 2: Synthesis of PILs

### Example 2(a): Synthesis of PILPCHDI-Cl

PCD (0.04 mol) is melted in the reactor, then the catalyst DBTDL (0.1% by weight) and 50 mL of MEK are added and, after measuring the reaction temperature of 70° C., HDI is added (0.047 mol) dissolved in MEK, forming a prepolymer. After the formation of the prepolymer, [GLYMIM]Cl (0.11 mol) is added. After homogenization of the solution, HDI (0.11 mol) dissolved in MEK is added to form PIL. The end of the reaction is accompanied by the disappearance of the free NCO band (around 2270 cm⁻¹) in the infrared spectrum.

The PILs synthesized in this and other examples all have the counter cation [GLYMIM]⁺ and were labeled as PILWX-Y, where W is the polyol (e.g., PL=PCL; PC=PCD; PTMG=PG), X is the diisocyanate (HDI, H12MDI, MDI, IPDI), and Y is the counter anion (Cl, NT₂F, BF₄, PF₆).

### Example 2 (b): Synthesis of PILPCHDI-NT₂F

PCD (0.04 mol) is melted in the reactor, then the catalyst DBTDL (0.1% by weight) and 50 mL of MEK are added and, after measuring the reaction temperature of 70° C., HDI is added (0.047 mol) dissolved in MEK, forming a prepolymer. After the formation of the prepolymer, [GLYMIM]NT₂F (0.11 mol) is added. After homogenization of the solution, HDI (0.11 mol) dissolved in MEK is added to form PIL. The end of the reaction is accompanied by the disappearance of the free NCO band (around 2270 cm⁻¹) in the infrared spectrum.

### Example 2(c): Synthesis of PILPCHDI-BF₄

PCD (0.04 mol) is melted in the reactor, then the catalyst DBTDL (0.1% by weight) and 50 mL of MEK are added and, after measuring the reaction temperature of 70° C., HDI is added (0.047 mol) dissolved in MEK, forming a prepolymer. After the formation of the prepolymer, [GLYMIM]BF₄ (0.11 mol) is added. After homogenization of the solution, HDI (0.11 mol) dissolved in MEK is added for the formation of PIL. The end of the reaction is accompanied by the disappearance of the free NCO band (around 2270 cm⁻¹) in the infrared spectrum.

### Example 2(d): Synthesis of PILPCHDI-PF₆

PCD (0.04 mol) is melted in the reactor, then the catalyst DBTDL (0.1% by weight) and 50 mL of MEK are added and, after measuring the reaction temperature of 70° C., HDI is added (0.047 mol) dissolved in MEK, forming a prepolymer. After the formation of the prepolymer, [GLYMIM]PF₆ (0.11 mol) is added. After homogenization of the solution, HDI (0.11 mol) dissolved in MEK is added to form PIL. The end of the reaction is accompanied by the disappearance of the free NCO band (around 2270 cm⁻¹) in the infrared spectrum.

### Example 2(e): Characterization of PILs

The synthesized PILs were characterized by Fourier Transform Infrared Spectroscopy (FTIR, PerkinElmer Spectrum 100 spectrometer) in transmission mode in the 4000 to 650 cm⁻¹ range, to verify the structures.

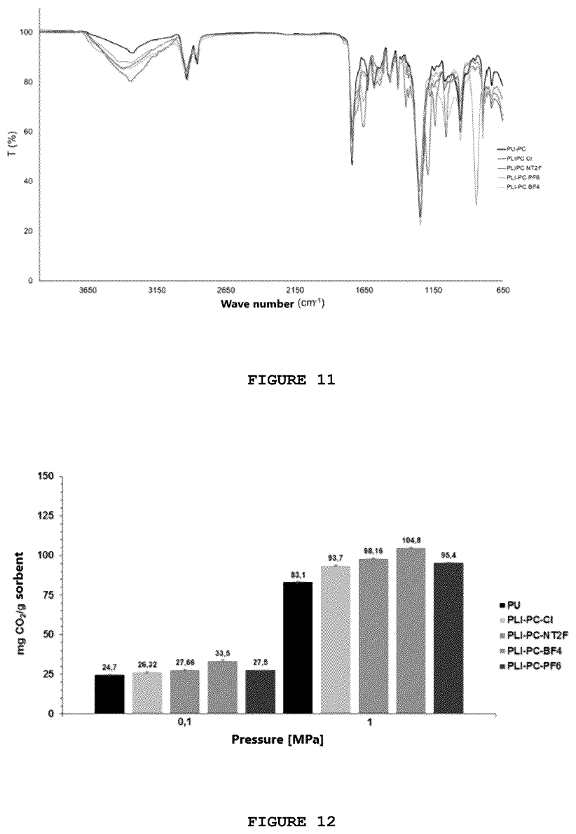

The synthesis of PILs could be confirmed by FTIR analysis, where it was possible to observe the characteristic bands of the PILs structure for all samples. FIG. 11 shows the typical spectra obtained for PILs synthesized with HDI diisocyanate, polycarbonate diol (PCD) MM=2000 gmol⁻¹ and different ILs ([GLYMIM]Cl, [GLYMIM]BF₄, [GLYMIM]PF₆, [GLYMIM]NT₂F). For comparison, FIG. 11 also shows a typical spectrum of polyurethane (PU) obtained with HDI diisocyanate and PCD polyol MM=2000 gmol−1.

FTIR spectra reported characteristic bands found for PUs: 2936 to 2871 cm⁻¹ (CH₂ and CH₃ stretching), 1536 cm⁻¹ (N—H groups), 1246 cm⁻¹ (C—N and C—O groups vibration of urethane), 1041 cm⁻¹ (C—O—C groups stretching of urethane) and 955 cm⁻¹ (C—O—C groups stretching of polycarbonate diol) (Bernard, F. L. et al. CO₂ capture: Tuning cation-anion interaction in urethane based poly(ionic liquids). Polymer (Guildf) 102, 199 to 208 (2016); Guo, J., Zhao, M., Ti, Y. & Wang, B. Study on structure and performance of polycarbonate urethane synthesized via different copolymerization methods. J Mater Sci 42, 5508 to 5515 (2007); and MagalhAes, T. O. et al. Syntheses and characterization of new poly(ionic liquid)s designed for CO₂ capture. RSC Adv 4, 18164 to 18170 (2014)).

The absence of the characteristic band of the stretching vibration of the N═C═O group in the region of 2270 cm⁻¹ confirms the non-existence of free NCO groups in the polymeric material, which indicates the formation of the polymer (Bernard, F. L. et al. CO₂ capture: Tuning cation-anion interaction in urethane based poly(ionic liquids). Polymer (Guildf) 102, 199 to 208 (2016); Rogulska, M. Polycarbonate-based thermoplastic polyurethane elastomers modified by DMPA. Polymer Bulletin 76, 4719 to 4733 (2019); da Luz, M. et al. Poly(ionic liquid)s based polyurethane blends: effect of polyols structure and ILs counter cations in CO₂ sorption performance of PILs physical blends. Polymer Bulletin (2021) doi:10.1007/s00289-021-03799-3; and Morozova, S. M. et al. Ionic Polyurethanes as a New Family of Poly(ionic liquid)s for Efficient CO₂ Capture. Macromolecules 50, 2814 to 2824 (2017)). The region between 3200 to 3500 cm⁻¹ corresponds to the stretching vibration of the N—H group of the urethane and the region between 1700 to 1730 cm⁻¹ is characteristic of the bonded and unbonded carbonyl groups, respectively (Pavlicevid, J. et al. Separation and Thermal Properties of Polycarbonate-Based. Macedonian Journal of Chemistry and Chemical Engineering 32, 151 to 161 (2013); Costa, V. et al. Structure-property relationships of polycarbonate diol-based polyurethanes as a function of soft segment content and molar mass. J Appl Polym Sci 132, 1 to 10 (2015)).

Shifts in the characteristic bands (N—H and C=O) indicate possible H-bonds. FIG. 11 shows the characteristic bands of the stretching vibration of the urethane N—H groups, where the region around 3400 cm⁻¹ corresponds to the unbonded N—H groups and the band in the region of 3300 cm⁻¹ characterizes the vibration of the bonded N—H groups. All PILs showed an increase in intensity in the bonded NH regions, indicating that the N—H groups of these samples may be participating in hydrogen bonds due to the LI-PU interaction. Regarding the PU structure, it is possible to observe the bands corresponding to unbound carbonyl groups close to 1730 cm⁻¹ and bound carbonyl groups close to 1700 cm⁻¹ (da Luz, M. et al. Poly(ionic liquid)s based polyurethane blends: effect of polyols structure and ILs counter cations in CO₂ sorption performance of PILs physical blends. Polymer Bulletin (2021) doi:10.1007/s00289-021-03799-3).

Changes in the spectrum that occur only when the IL is inserted were also noted, the appearance of a shoulder at 1700 cm⁻¹ and the appearance of a band at 1650 cm⁻¹ may also indicate the interaction of the IL with the polymer chain (Bernard, F. L. et al. CO₂ capture: Tuning cation-anion interaction in urethane based poly(ionic liquid)s. Polymer (Guildf) 102, 199 to 208 (2016); da Luz, M. et al. Poly(ionic liquid)s-based polyurethane blends: effect of polyols structure and ILs counter cations in CO₂ sorption performance of PILs physical blends. Polymer Bulletin (2021) doi:10.1007/s00289-021-03799-3; Bernard, F. L. et al. Polyurethane-based poly (ionic liquid)s for CO₂ removal from natural gas. J Appl Polym Sci 136, (2019)). The PIL-PCHDI-BF₄ sample shows a broadened band near 1050 cm⁻¹ which indicates the presence of the B—F bond. The PILPCHDI-PF₆ sample shows a band near 830 cm⁻¹ referring to the P—F bonds. For the PIL-PCHDI-NT₂F sample, a band close to 1349 cm⁻¹ related to the vibrations of the SO₂ bonds was observed, as well as bands close to 1130 and 1180 cm⁻¹ related to the vibrations of the C—F bond (MagalhAes, T. O. et al. Syntheses and characterization of new poly(ionic liquid)s designed for CO₂ capture. RSC Adv 4, 18164 to 18170 (2014); Yu, G. et al. New crosslinked-porous poly-ammonium microparticles as CO₂ adsorbents. React Funct Polym 73, 1058 to 1064 (2013); Vollas, A., Chouliaras, T., Deimede, V., Ioannides, T. & Kallitsis, J. New pyridinium type poly(ionic liquid)s as membranes for CO₂ separation. Polymers (Basel) 10, (2018); Zhang, Z. et al. Effect anions on the hydrogenation of nitrobenzene over N-rich Poly(ionic liquid) supported Pd catalyst. Chemical Engineering Journal 429, 132224 (2022)).

Differential Scanning Calorimetry (DSC, TA Instruments Q20) was used to determine the glass transition temperature (Tg), melting temperature (Tm) and crystallization temperature (Tc) of the PILs. The tests were performed with two heating ramps and one cooling ramp in the range of −90 to 200° C. at 10° C./min under an inert nitrogen atmosphere.

The results of DSC analyses (Table 2) show that all PIL samples had glass transition temperatures (Tg) close to each other, the results found were −44.7, −47.9, −43.2, and −42.7° C. for the PIL-PCHDI-Cl, PIL-PCHDI-NT₂F, PIL-PCHDI-PF₆, PIL-PCHDI-BF₄ samples, respectively. When comparing the values obtained for the PILs with the results obtained for pure PU (−42° C.), it is possible to notice a decrease in the Tg values for all PILs in relation to the non-ionic PU, which may mean that the addition of ILs in the polymer chain increases the separation of the polymer microphases.

It was also possible to identify the existence of an endothermic peak which can be attributed to a fusion of the crystalline microphase (Tmf). This endothermic peak is characteristic for the material used in the polymer chain (PCD) with a molar mass of 2000 gmol⁻¹ and does not reflect the fusion of the material. The results found for the samples PU, PILPCHDI-Cl, PILPCHDI-NT₂F, PILPCHDI-PF₆ and PILPCHDI-BF₄ were respectively 40.1° C., 42.2° C., 46.4° C., 42.8° C. and 43.5° C. Finally, the crystallization temperature (Tc) was obtained for the PILPCHDI-Cl sample (−12.7° C.).

TABLE 2
Tmf, Tc and Tg values found through DSC analysis

| Sample | Tg (° C.) | Tmf (° C.)* | Tc (° C.) |
|---|---|---|---|
| PUPC | −42.0 | 40.1 | — |
| PLIPCHDI-Cl | −44.7 | 42.2 | −12.7 |
| PLIPCHDI-NT₂F | −47.9 | 46.4 | — |
| PLIPCHDI-PF₆ | −43.2 | 42.8 | — |
| PLIPCHDI-BF₄ | −42.7 | 43.5 | — |

*crystalline microphase melting.

The thermal stability of the PILs was verified by means of thermogravimetric analysis (TGA) using TA Instruments model Q600 equipment, ranging from room temperature to 600° C., with a heating ramp of 10° C./min in a nitrogen atmosphere.

The results of thermogravimetric analysis (Table 3) demonstrated that the cationic PILs containing the imidazole cation and the different anions (Cl, NT₂F, BF₄, PF₆) have good thermal stability (between 246 and 330° C.).

TABLE 3
Decomposition temperatures of cationic PILs

| Sample | Tᵢₙᵢₜᵢₐₗ₁ (° C.) | Tᵢₙᵢₜᵢₐₗ₂ (° C.) |
|---|---|---|
| PLIPCHDI-Cl | 282 | 407 |
| PLIPCHDI-NT₂F | 246 | 387 |
| PLIPCHDI-BF₄ | 330 | 388 |
| PLIPCHDI-PF₆ | 307 | 395 |

The mechanical analyses were performed in triplicate, according to the ASTM D822 technical standard on a TA Instruments Q800 equipment, to determine the Young's modulus and obtain the stress x deformation curves.

From the stress x deformation curves of the PILs, it was possible to obtain the Young's modulus of the samples, as shown in Table 4. The results were 53 MPa, 16.4 MPa, 7 MPa, 29 MPa and 47 MPa respectively for the PU, PILPCHDI-Cl, PILPCHDI-NT₂F, PILPCHDI-PF₆, PILPCHDI-BF₄ samples. In increasing order, in terms of Young's modulus, we have that PILPCHDI-NT₂F<PILPCHDI-Cl<PILPCHDI-PF₆<PILPCHDI-BF₄<PU-non-ionic.

TABLE 4
DMA results for cationic PIL samples

| | Young' s | Stress | Deformation |
|---|---|---|---|
| Sample | modulus (MPa) | (MPa) | (%) |
| PU-PC | 53 ± 1 | 8 ± 0.2 | 120 ± 6 |
| PLIPCHDI-Cl | 16 ± 0.1 | 2.4 ± 0.3 | 138 ± 4 |
| PLIPCHDI-NT₂F | 7 ± 0.5 | 0.6 ± 0.1 | 20 ± 5 |
| PLIPCHDI-BF₄ | 47 ± 7 | 5 ± 0.2 | 148 ± 7 |
| PLIPCHDI-PF₆ | 29 ± 3 | 4 ± 0.3 | 134 ± 1 |

### Example 3: Sorption Test of PILs

The CO₂ sorption capacity of PILs was determined by the pressure decay technique using a double-chamber cell that is similar to the system reported in the literature (Bernard, F. L. et al. Polyurethane-based poly (ionic liquid)s for CO₂ removal from natural gas. J Appl Polym Sci 136, 4 to 11 (2019); Ferndndez, M., Carreno, L. A., Bernard, F., Ligabue, R. & Einloft, S. Poly(ionic liquid) s Nanoparticles Applied in CO₂ Capture. Macromol Symp 368, 98 to 106 (2016); Bernard, F. L. et al. CO₂ capture: Tuning cationanion interaction in urethane based poly(ionic liquids). Polymer (Guildf) 102, 199 to 208 (2016) and Bernard, F. L. et al. Cellulose based poly(ionic liquid)s: Tuning cation-anion interaction to improve carbon dioxide sorption. Fuel 211, 76 to 86 (2018)). The samples (˜1.0 g) were placed in the sorption chamber and degassed under vacuum (10⁻³ mbar, 10⁻⁶ MPa) for 1 h at room temperature. The CO₂ sorption experiments were performed at 30° C. at different equilibrium pressures (0.1 MPa and 1 MPa (1 bar and 10 bar, respectively)).

TABLE 5
Sorption results for the synthesized PILs
at 0.1 and 1 MPa (1 and 10 bar) at 25° C.

| | CO₂ | | CO₂ | |
|---|---|---|---|---|
| | sorption | Conditions | sorption | Conditions |
| PIL | (mg/g) | (P, T) | (mg/g) | (P, T) |
| PLIPCHDI-Cl | 26.3 | 0.1 MPa | 93.7 | 1 MPa |
| | | (1 bar), | | (10 bar), |
| | | 303.15K | | 303.15K |
| PLIPCHDI-NT₂F | 27.6 | 0.1 MPa | 98.2 | 1 MPa |
| | | (1 bar), | | (10 bar), |
| | | 303.15K | | 303.15K |
| PLIPCHDI-BF₄ | 33.5 | 0.1 MPa | 104.8 | 1 MPa |
| | | (1 bar), | | (10 bar), |
| | | 303.15K | | 303.15K |
| PLIPCHDI-PF₆ | 27.5 | 0.1 MPa | 95.4 | 1 MPa |
| | | (1 bar), | | (10 bar), |
| | | 303.15K | | 303.15K |

Furthermore, the CO₂ capture results can be observed in FIG. 11. From the values found, it can be seen that increasing the pressure also increases the amount of CO₂ captured. This behavior is typical of samples that perform CO₂ sorption by physical interaction, which is the case of cationic PILs.

The results found for the non-ionic PU sample were 24.7 mg CO₂/g (0.1 MPa; 1 bar) and 83.1 mg CO₂/g (1 MPa; 10 bar). This result can be attributed to the interactions between CO₂ and the polar groups composed of nitrogen and oxygen in the structure of the PU polymer chain. It is possible to see that the insertion of the IL leads to an increase in the CO₂ capture values for all PIL samples. The sorption capacity increases in the following order: [Cl]⁻<[PF₆]⁻<[NT₂F]⁻<[BF₄]⁻ for 0.1 MPa and 1 MPa (1 and 10 bar), demonstrating that the type of anion chosen can influence CO₂ capture.

The PILs were also subjected to ten successive sorption cycles at 1 MPa (10 bar) and 303.15 K, and subsequent CO₂ desorption using vacuum at room temperature for 1 hour, and the results demonstrated the recycling capacity of these materials.

### Example 4: Ideal Permeability and Selectivity Test of PIL Membranes

The CO₂ permeability and ideal CO₂/CH₄ selectivity of the PIL membranes were evaluated in a system with two plates that join in an orifice with a diameter of approximately 4 cm, where the membrane is inserted. The membrane and system were vacuumed before the gases were fed. CO₂ or CH₄ gas was fed at a pressure of 0.4 MPa (4 bar). At the bottom, a pressure transducer computed the amount of gas passing through the membrane versus time (dP/dt). The permeability was determined from the slope (dP/dt) of the linear portion of the pressure versus time using Equation 1.

$$\frac{P}{l} = \frac{dP}{dt} ( \frac{{V}_{System}}{A Δ P} ) ( \frac{{T}_{STP}}{T {P}_{STP}} ) \qquad ( 1 )$$

where l is the membrane thickness; P is the permeability, ΔP is the pressure difference between the two sides of the membrane; A corresponds to the membrane area; V_{System} is the volume of the permeation cell; T is the room temperature; T_{STP} and P_{STP} are, respectively, the temperature and pressure under normal conditions. The ideal selectivity was calculated from Eq. (2), dividing the CO₂ permeabilities by CH₄.

$${∝}_{CO 2 / CH 4} = \frac{PCO 2}{PCH 4} \qquad ( 2 )$$

The permeance (in GPU) applied to the composite membranes is calculated by equation 1, without multiplication by the thickness term.

Table 6 shows the results of CO₂ permeability and ideal selectivity (CO₂/CH₄) obtained for the dense PIL membranes, in comparison with the results for cellulose acetate found in the literature. All PIL samples tested showed superior CO₂/CH₄ selectivity to cellulose acetate.

It is also worth noting that the PIL-PCHDIBF₄ sample showed the best permeability and selectivity results. In its turn, the samples prepared with the counter anions Cl and PF₆ still showed higher selectivities when compared to cellulose acetate samples from the literature (Raza, A. et al. Performance analysis of blended membranes of cellulose acetate with variable degree of acetylation for CO₂/CH₄ separation. Membranes (Basel) 11, (2021); Mubashir, M., Yeong, Y. F., Lau, K. K., Chew, T. L. & Norwahyu, J. Efficient CO₂/N₂ and CO₂/CH₄ separation using NH₂-MIL-53 (Al)/cellulose acetate (CA) mixed matrix membranes. Sep Purif Technol 199, 140 to 151 (2018)).

Permeability and selectivity increased when the Cl⁻ anion was replaced by BF₄⁻, indicating that the presence of fluorine in PILs can increase the affinity for CO₂. However, interestingly, the PF₆⁻ anion showed lower permeability and selectivity when compared to the other anions. This behavior may be related to the size of the anion. The size of the anions used in this work follows the following general trend Cl⁻<BF₄⁻<PF₆⁻<TF₂N^{-16.35}. Thus, although BF₄⁻ and PF₆⁻ have similar structures, the PF₆ anion has a larger size.

TABLE 6
Results of the ideal permeability and selectivity
tests, at 0.4 MPa (4 bar) and 25° C.

| | CO₂ perm. | CH₄ perm. | Ideal CO₂/CH₄ |
|---|---|---|---|
| Membrane | (barrer) | (barrer) | selec. |
| PLIPCHDI-Cl | 17.4 | 0.5 | 35 |
| PLIPCHDI-PF₆ | 8.4 | 0.3 | 28 |
| PLIPCHDI-BF₄ | 43 | 0.36 | 119 |
| 1 - CTA | 18 | 1.98 | 9 |
| (25° c., 0.5 | | | |
| MPa (5 bar)) | | | |
| 2 - CA | 15 | 1.45 | 10 |
| (25° c., 0.3 | | | |
| MPa (3 bar)) | | | |
| 3 - CA | 4 | 0.2 | 17 |
| (25° c., 0.1 | | | |
| MPa (1 bar)) | | | |
| 4 - CA | 4.3 | 0.21 | 21 |
| (35° c., 0.3 | | | |
| MPa (3 bar)) | | | |

1—Raza, A. et al. Performance analysis of blended membranes of cellulose acetate with variable degree of acetylation for CO₂/CH₄ separation. Membranes (Basel) 11, (2021);
2—Mubashir, M., Yeong, Y. F., Lau, K. K., Chew, T. L. & Norwahyu, J. Efficient CO₂/N₂ and CO₂/CH₄ separation using NH₂-MIL-53(Al)/cellulose acetate (CA) mixed matrix membranes. Sep Purif Technol 199, 140 to 151 (2018);
3—Sajjan, P. et al. Fabrication of Cellulose Acetate Film through Blending Technique with Palladium Acetate for Hydrogen Gas Separation. Energy and Fuels 34, 11699 to 11707 (2020); and
4—Akbarzadeh, E., Shockravi, A. & Vatanpour, V. High performance compatible thiazole-based polymeric blend cellulose acetate membrane as selective CO₂ absorbent and molecular sieve. Carbohydr Polym 252, (2021).

The results of the ideal permeability and selectivity obtained demonstrated that the synthesized PIL membranes are extremely promising for separation (CO₂/CH₄). It can be observed that the cationic PIL samples prepared with different counter anions showed good permeability and high selectivity to CO₂.

### Example 5: Preparation of Dense Membranes from PILs

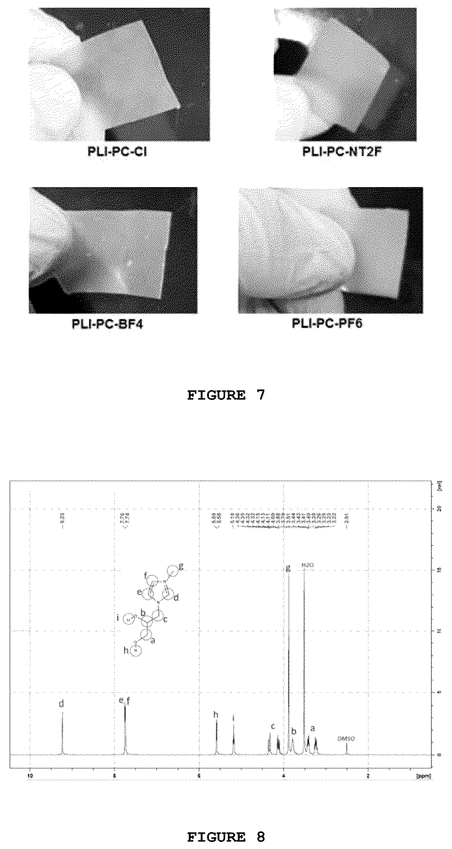

Initially, solutions of the polycarbonate PILs and hexamethylene diisocyanate of the ILs [GLYMIM]Cl, [GLYMIM]PF₆, [GLYMIM]BF₄ and [GLYMIM]NT₂F at 20% by weight were prepared by dissolving 2 g of PIL in 10 mL of methyl ethyl ketone via magnetic stirring and heating (50° C.) until the PIL was completely dissolved. The solutions were applied to a flat surface such as a glass plate or a Petri dish, and then the solvent was allowed to evaporate at room temperature for five days. FIG. 7 shows the membranes obtained after drying the PILs.

The molar masses of the PIL membranes and their distribution were determined by means of Gel Permeation Chromatography (GPC), the chromatograms were obtained with the isocratic pump-1515 HPLC chromatograph using a Waters Instruments 2412 refractive index detector and THF as eluent.

Table 7 shows typical molar mass values, thermal and mechanical properties of cationic PILs synthesized with HDI, PCD MM=2000 gmol⁻¹ and different ILs ([GLYMIM]Cl, [GLYMIM]BF₄, [GLYMIM]PF₆, [GLYMIM]NT₂F). The molar mass distributions (PD, polydispersity) and weighted molar masses (Mw) of the PILs, obtained by Gel Permeation Chromatography (GPC) are shown in Table 7. The Mw values ranged from 43.264 gmol⁻¹ to 70,655 gmol⁻¹, while the polydispersity (PD) ranged from 1.22 to 1.42.

TABLE 7
GPC results of cationic PILs

| Samples | Mw (gmol⁻¹) | PD |
|---|---|---|
| PLIPCHDI-Cl | 48311 | 1.36 |
| PLIPCHDI-NT₂F | 45485 | 1.22 |
| PLIPCHDI-BF₄ | 43264 | 1.42 |
| PLIPCHDI-PF₆ | 70655 | 1.24 |

### Example 6: Preparation of a PILPCHDINT₂F Composite Membrane on Nylon

First, a PILPCHDINT₂F solution was prepared in tetrahydrofuran (THF) (10% w/w), after which the solution was placed under magnetic stirring and heated (50° C.) to completely dissolve the PIL. Then, the solution was applied to the nylon support by casting. Finally, the composite membrane was dried at room temperature for 7 days.

Field Emission Scanning Electron Microscopy (FEI Inspect F50) analyses were performed in secondary electron (SE) mode to evaluate the surface of the composite membranes.

The tests performed without the PIL layer were not able to block the CO₂, with the passage of the gas through the membrane being practically instantaneous. When PIL-PCHDI-NT₂F was supported on 0.22 μm nylon, a CO₂ permeance of 48.5 GPU at 0.4 MPa (4 bar) and 25° C. was achieved. Thus, through this CO₂ permeability test, it was possible to observe that the use of a support can promote a significant increase in CO₂ permeability when a thin layer of PIL is obtained.

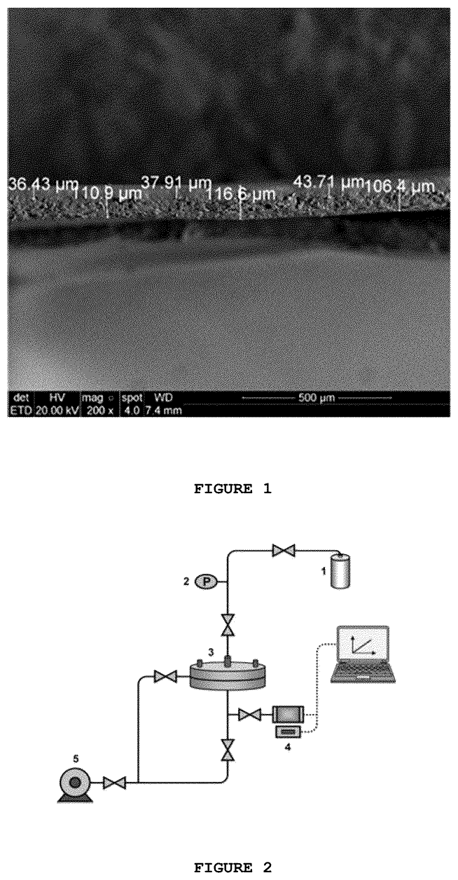

The cross-sectional image of the membrane supported on 0.22 μm nylon is shown in FIG. 1. A thin, dense and defect-free layer can be observed deposited on the nylon support. Based on the cross-sectional image, the membrane structure is homogeneous with a thickness of 37.91±3.84 μm.

1. Urethane cationic poly(ionic liquid) having formula (I): 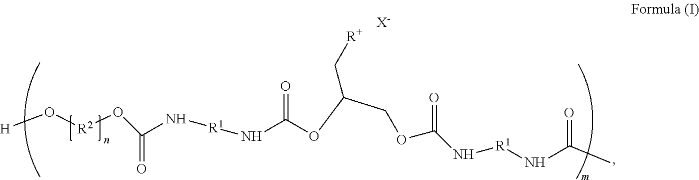
wherein X— is a counter anion selected from Cl⁻, Br⁻, I⁻, TFO⁻, SCN⁻, FAP⁻, DCA⁻, NO₃⁻, ClO₄⁻, NT₂F⁻, BF₄⁻, PF₆⁻, bis (pentafluoroethylsulfonyl)imidate, tricyanomethide, taurinate, tetracyanoborate, formate, acetate, propionate and butyrate;
R¹ is a C₁-C₆ alkyl group; C₃-C₈ cycloalkyl, optionally substituted with C₁-C₆ alkyl; mono- or bicyclic 6- to 10-membered aryl, optionally substituted with C₁-C₆ alkyl; C₆ aryl-C₁-C₆ alkyl-(C₆ aryl) 1-2; or C₁-C₆ alkyl-C6 aryl-C₁-C₆ alkyl;
R² is a polyether, polyester, polycarbonate diol, polytetramethylene glycol, polycaprolactone, acrylic, polybutadiene, or aliphatic C₄-C₁₀ alkyl group;
R is 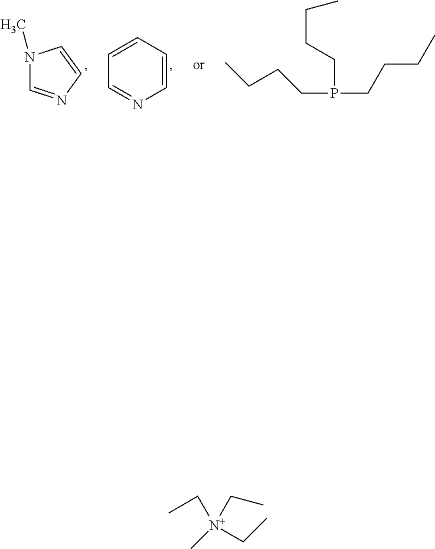
n is an integer between 4 and 45; and
m is an integer between 15 and 150.

2. The urethane cationic poly(ionic liquid) according to claim 1, wherein the radical R² is a polycarbonate diol (PCD), polytetramethylene glycol (PTMG) or polycaprolactone (PCL) group.

3. The urethane cationic poly(ionic liquid) according to claim 1, wherein the radical R² is a polycarbonate diol group.

4. The urethane cationic poly(ionic liquid) according to claim 1, wherein the radical R¹ is derived from a diisocyanate selected from the group consisting of hexamethylene diisocyanate (HDI), isophorone diisocyanate (IPDI), 4,4-dicyclohexylmethane diisocyanate (H12MDI), 4,4′-diphenyl methane diisocyanate (MDI), 2,4′-diphenyl methane diisocyanate (MDI), 2,2′-diphenyl methane diisocyanate (MDI), 2,4-toluene diisocyanate (TDI), 2,6-toluene diisocyanate (TDI), meta-tetramethylxylene diisocyanate (TMXDI), triphenylmethane-4,4′,4″-triisocyanate and naphthalene 1,5-diisocyanate.

5. The urethane cationic poly(ionic liquid) according to claim 1, wherein the radical R¹ is derived from a diisocyanate selected from the group consisting of hexamethylene diisocyanate (HDI), isophorone diisocyanate (IPDI), 4,4-dicyclohexylmethane diisocyanate (H12MDI), 4,4′-diphenyl methane diisocyanate (MDI), 2,4′-diphenyl methane diisocyanate (MDI) and 2,2′-diphenyl methane diisocyanate (MDI).

6. The urethane cationic poly(ionic liquid) according to claim 1, wherein the radical R¹ is derived from hexamethylene diisocyanate (HDI).

7. The urethane cationic poly(ionic liquid) according to claim 1, wherein the counter anion is selected from the group consisting of Cl⁻, BF₄⁻ and PF₆⁻.

8. The urethane cationic poly(ionic liquid) according to claim 1, wherein the counter anion comprises BF₄⁻.

9. The urethane cationic poly(ionic liquid) according to claim 1, wherein the radical R comprises

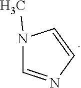

10. The urethane cationic poly(ionic liquid) according to claim 1, wherein the counter anion comprises BF₄⁻, the radical R¹ is derived from hexamethylene diisocyanate (HDI), the radical R² is a polycarbonate diol group and R comprises

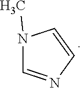

11. A dense membrane comprising being based on a urethane cationic poly(ionic liquid) as defined in claim 1.

12. A composite membrane comprising a urethane cationic poly(ionic liquid) as defined in claim 1, and a support polymer selected from nylon, polytetrafluoroethylene (PTFE), polyvinylidene fluoride (PVDF), cellulose acetate, cellulose nitrate, cellulose ester (MCE) and polyethersulfone (PES).

13. A method of use of a dense membrane as defined in claim 11, the method comprising removing CO₂ from natural gas or exhaust gas with the dense membrane.

14. A method of use of a composite membrane as defined in claim 12, the method comprising removing CO₂ from nature gas or exhaust gas with the composite membrane CO₂ from natural gas or exhaust gas.

15. A method for removing co₂ from natural gas or exhaust gas, comprising subjecting a stream of natural gas or exhaust gas to a dense membrane as defined in claim 11.

16. A method for removing co₂ from natural gas or exhaust gas, comprising subjecting a stream of natural gas or exhaust gas to a composite membrane as defined in claim 12.
